(19) United States
(12) Patent Application Publication
(10) Pub. No.: US 2005/0209960 A1
(43) Pub. Date: Sep. 22, 2005

(54) Electronic transaction system, wide area network printing system, and communications terminal

(75) Inventor: Katsushi Horihata, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 10/805,694

(22) Filed: Mar. 22, 2004

(51) Int. Cl. G06F 17/60

(52) U.S. Cl. 705/39

(57) ABSTRACT

In an electronic transaction system, a password authenticating section of the portable telephone judges whether the password inputted on the operating section of the accounting control device coincides with the password stored in the portable telephone. If the judgment result is affirmative, the controlling section of the portable telephone controls the communicating section thereof to send a notification that the password matching is established to the accounting control device, and controls an electronic money information altering section thereof to alter the amount of electronic money stored in an electronic money storing section thereof in accordance with the command requesting subtraction of electronic money.

### BACKGROUND OF THE INVENTION

1. Field of the Invention

The present invention relates to an electronic transaction system in which users are allowed to make settlement by electronic transaction by data communication with communications terminals storing information relating to electronic money, and a wide area printing system using the electronic transaction system.

2. Description of the Related Art

Heretofore, there has been known a network printing system in which a user can retrieve information stored in a server via the Internet with use of an image forming apparatus which is installed remotely away from the server but is communicatively connected therewith via the Internet to print a desired document by a printer incorporated in the image forming apparatus. Such a system is disclosed in Japanese Unexamined Patent Publication No. 2002-32205, for example. In the network printing system, there are proposed various settlement methods of print fees such as the method (a) in which users pay the print fee by cash each time the print fee payment is requested, the method (b) in which users make advance payment by purchasing so-called prepaid cards prior to printing, and the method (c) in which the sum of the print fees which are due by a predetermined due date is calculated periodically, and the users are charged of the sum of the print fees periodically.

The above settlement methods have various drawbacks. For instance, in the case of the method (a), the users are required to hold a certain amount of cash on site each time printing is conducted. In the case of the method (b), it is difficult for the users to grasp how much money will be subtracted from the prepaid card regarding the print fee each time printing is conducted. Further, in the case of the method (b), if the prepaid card is of a disposable type in which the history of the used amounts is recorded on the backside of the card, the card is void and discarded once the prepaid amount is used up, which is not economical. In the case of the method (c), since the users find it difficult to predict the sum of the print fees which are due by the predetermined due date, it is likely that the users are charged of an unexpectedly heavy cost regarding the print fees.

### SUMMARY OF THE INVENTION

In view of the above, it is an object of the present invention to overcome the problems residing in the prior art. It is another object of the present invention to provide an electronic transaction system which makes it possible for users to make cashless settlement in transaction and for the users to easily grasp the history of used amounts of money, and is economically advantageous, as well as a wide area printing system using the electronic transaction system.

According to an aspect of the present invention, in an electronic transaction system provided with a communications terminal storing information relating to electronic money therein, and an accounting control device for allowing users to make settlement by electronic transaction by data communication with the communications terminal, the communications terminal includes: a storing unit that stores a certain amount of electronic money therein; an electronic money information altering unit that alters the amount of electronic money stored in the storing unit in response to an instruction from the accounting control device; and a display that displays the amount of electronic money stored in the storing unit, and the accounting control device includes: a deposit money storing unit that stores a certain amount of electronic money deposited in the communications terminal therein; a transmitting unit that transmits a command requesting addition or subtraction of electronic money to the communications terminal; and an electronic money administering unit that alters the amount of electronic money stored in the deposit money storing unit in response to the command requesting addition or subtraction of electronic money sent from the transmitting unit.

In the above arrangement, the amount of electronic money is stored in the storing unit of the communications terminal and altered based on the instruction from the accounting control device, and the display displays the amount of electronic money stored in the storing unit accordingly. Referring to the operations of the accounting control device, the deposit money storing unit stores the amount of electronic money deposited in the communications terminal. If the amount of electronic money stored in the storing unit of the communications terminal is altered, the electronic money administering unit administers the balance of electronic money by altering the amount of electronic money stored in the deposit money storing unit in accordance with the alteration of the amount of electronic money deposited in the communications terminal. With this arrangement, by utilizing the communications terminal and the accounting control device in settlement by electronic transaction, cashless electronic settlement is feasible. Further, the users can easily grasp, through the display of the communications terminal, the history of transaction such as the used amount of electronic money in each transaction, and the balance of electronic money deposited in the communications terminal. According to this arrangement, since data is rewritable an unlimited number of times by utilizing the memory in the communications terminal as the storing unit of the communications terminal, the system is also advantageous from an economical viewpoint.

These and other objects, features and advantages of the present invention will become more apparent upon reading of the following detailed description along with the accompanying drawings.

### BRIEF DESCRIPTION OF THE DRAWINGS

FIG. 1 is an illustration showing an entire configuration of a wide area network printing system according to an embodiment of the present invention.

FIG. 2 is an illustration schematically showing data communication regarding print data among a communications terminal of a user, a document server, and a printer in the wide area network printing system.

FIG. 3 is a block diagram schematically showing an internal arrangement of the document server.

FIG. 4 is a block diagram schematically showing an internal arrangement of the printer.

FIG. 5 is a block diagram schematically showing an internal arrangement of a portable telephone, as an example of the communications terminal.

FIG. 6 is a block diagram schematically showing an internal arrangement of an accounting control device.

FIG. 7 is an illustration showing how electronic money information is communicated between the portable telephone and the accounting control device.

FIG. 8 is an illustration showing how payment by electronic money is settled between the portable telephone and the accounting control device in subtracting a certain amount of electronic money.

FIG. 9 is a flowchart showing a printing process by the printer in the wide area network printing system.

FIG. 10 is a flowchart showing processes by the document server and the printer in printing in the wide area network printing system.

FIGS. 11A and 11B are flowcharts showing altered processes by the document server and the printer in printing in the wide area network printing system.

FIGS. 12A and 12B are flowcharts showing further altered processes by the document server and the printer in printing in the wide area network printing system.

### DETAILED DESCRIPTION OF THE PREFERRED EMBODIMENTS

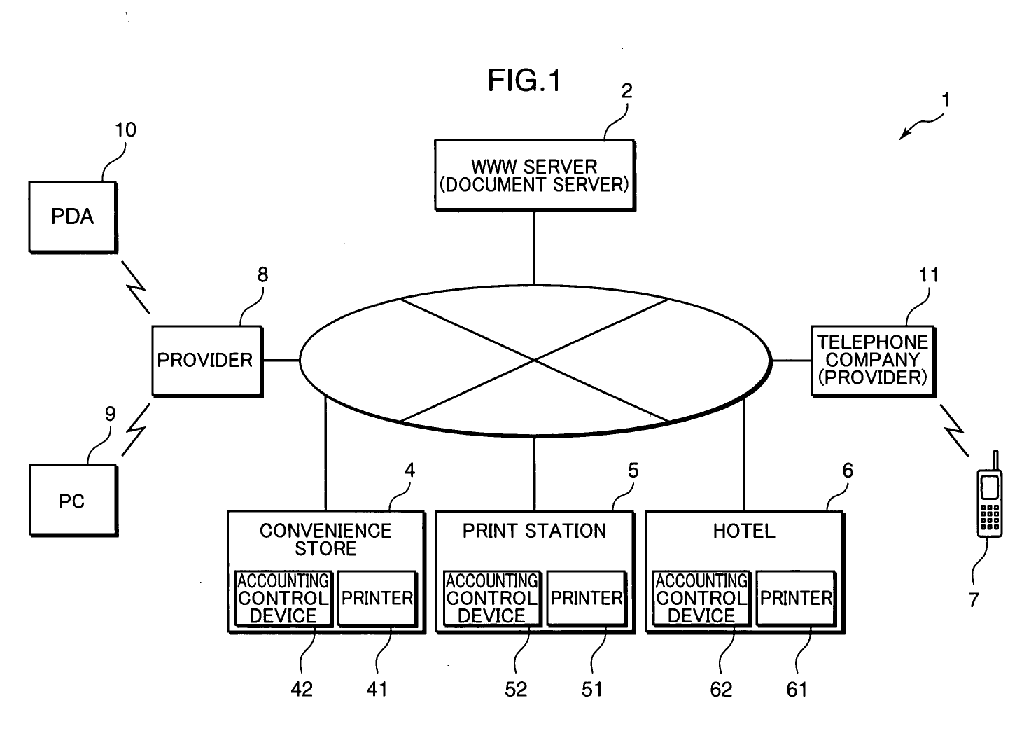

In the following, an electronic transaction system and a wide area network printing system according to a first embodiment of the present invention are described referring to the drawings. FIG. 1 is an illustration showing an entire configuration of the inventive wide area network printing system. The electronic transaction system embodying the present invention is adopted in the wide area network printing system shown in FIG. 1.

The system 1 is constructed in such a manner that print data stored in a document server 2 is sent via the Internet to a printer 41 (51 or 61) in a convenience store 4 (a print station 5 or a hotel 6) for printing. The printers 41, 51, 61 are installed remotely away from the document server 2 but are communicatively connected therewith via the Internet.

The document server 2 is a server equipped with a database storing various print data therein. For instance, distributors or like agents dealing with products or goods use the document server 2 to distribute among users print data including paid contents information (hereinafter, merely called as “paid contents”). Specifically, the document server 2 sends, to a communications terminal of each user such as a portable telephone 7, a personal computer (PC) 9, or a personal digital assistant (PDA) 10, a message indicating that print data including paid contents are printable, as well as a document ID for identifying each print data, by way of an electronic mail or the like.

The printers 41, 51, 61 installed in the convenience store 4, the print station 5, the hotel 6 or a like facility are communicatively connected with the document server 2 via the Internet to receive print data from the document server 2 for printout. The printer 41 (51, 61) may have a printing function solely, or may be a so-called complex machine equipped with multi functions such as a printer, a copier, and a facsimile machine.

Accounting control devices 42, 52, 62 are respectively provided in the convenience store 4, the print station 5, the hotel 6 for allowing the users to make settlement by electronic transaction by data communication with the communications terminal such as the portable telephone 7.

The reference numeral 8 denotes a provider which provides the users with services regarding connection with the Internet. The provider 8 allows the users to communicate data with the document server 2 via the Internet by way of the communications terminals such as the PCs 9 or the PDAs 10.

The reference numeral 11 denotes a telephone company. The telephone company 11 provides phone call services through the portable telephones 7, and provides services that enable the users to be accessible to the Internet from the portable telephones 7 for data communication. It is possible for the users to be accessible to the Internet by services of providers other than the telephone company 11. The portable telephone 7 has a data communication function, in addition to the ordinary phone call function.

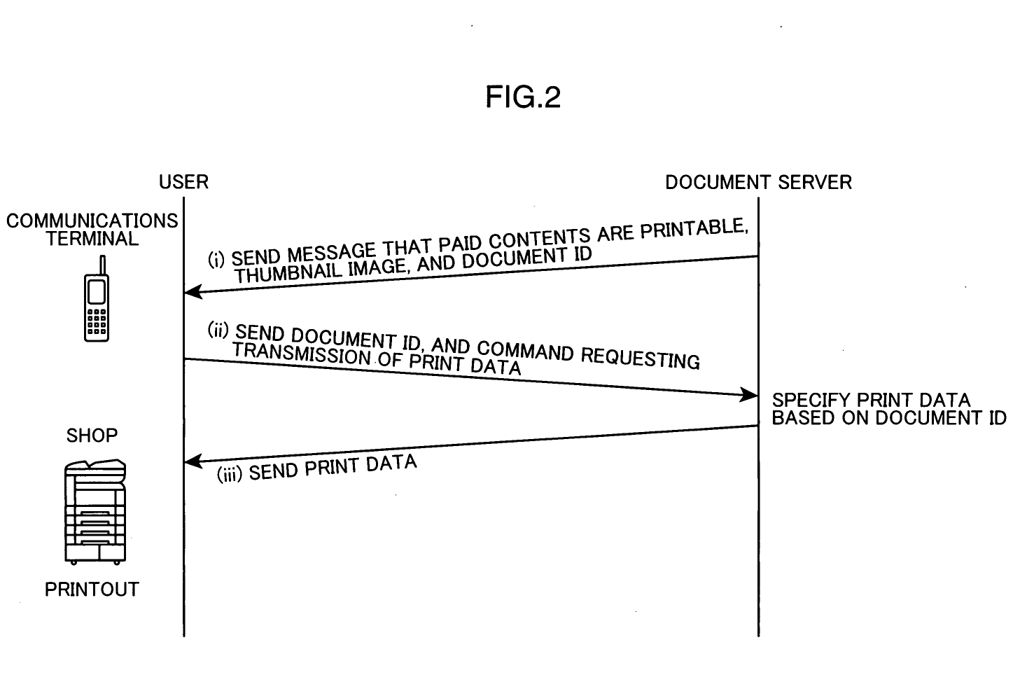

Next, described is an exemplified data communication among the communications terminal, the document server 2, and the printer 41 (51 or 61) regarding print data in the wide area network printing system 1. FIG. 2 is an illustration showing how data is communicated among the communications terminal, the document server 2, and the printer 41 (51 or 61) regarding print data in the wide area network printing system 1.

First, the document server 2, namely, a sender of paid contents, for example, distributes, to the communications terminal such as the portable telephone 7 of the user, a message indicating that the paid contents are printable, as well as thumbnail image data representing the paid contents in a reduced size, and a document ID for identifying each paid contents (see the step (i) in FIG. 2).

Next, upon receiving the message indicating that the paid contents are printable from the document server 2 by way of the communications terminal such as the portable telephone 7, the user confirms the paid contents in terms of the thumbnail image on the display of the portable telephone 7 or the like, and enters the document ID for identifying the paid contents with use of the printer 41 (51 or 61) installed in the convenience store 4, the print station 5, the hotel 6 or a like facility. In response to the entry of the document ID, the printer 41 (51 or 61) sends, to the document server 2, the document ID, and a command requesting transmission of the print data (paid contents) identified by the document ID. The user confirms the print data in terms of a thumbnail image sent from data sending/receiving unit of the document server 2 on the display of the portable telephone 7 or the like, and sends a command requesting transmission of the print data to the document server 2 by way of the printer 41 (51 or 61) (see the step (ii) in FIG. 2).

Upon receiving the document ID and the command requesting transmission of the print data from the printer 41 (51 or 61), the document server 2 sends, to the printer, the print data identified by the document ID (see the step (iii) in FIG. 2).

Thereafter, the print data is printed, and settlement of the print fee is executed by data communication between the communications terminal such as the portable telephone 7 and the accounting control device 42 (52 or 62).

In the above arrangement, there is no likelihood that the user inadvertently enters the document ID on the printer 41 (51 or 61) without recognizing the contents of the print data, because the user enters the document ID on the printer 41 (51 or 61) only after confirming the contents of the print data in terms of the thumbnail image on the display of the portable telephone 7 or the like. The document ID for identifying the print data requested by the user is securely sent from the printer 41 (51 or 61) to the document server 2. In this way, this arrangement is advantageous in preventing receiving and outputting of print data which is not requested by the users on the printer 41 (51 or 61), thereby allowing the user to obtain desired image data without fail.

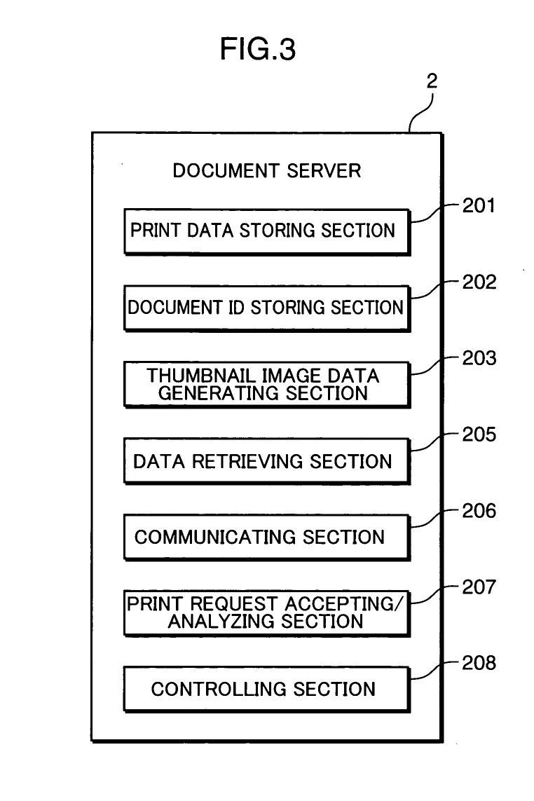

Next, an internal arrangement of the document server 2 is described. FIG. 3 is a block diagram schematically showing the internal arrangement of the document server 2. The document server 2 includes a print data storing section 201, a document ID storing section 202, a thumbnail image data generating section 203, a data retrieving section 205, a communicating section 206, a print request accepting/analyzing section 207, and a controlling section 208.

The print data storing section 201 stores the print data (paid contents) to be provided to the users. The print data to be transmitted to the printer 41 (51 or 61) is read out from the print data storing section 201 and sent to the printer 41 (51 or 61).

The document ID storing section 202 stores the document ID in association with the print data. The thumbnail image data generating section 203 generates thumbnail image data representing respective print data stored in the print data storing section 201. The data retrieving section 205 reads out, from the print data storing section 201, the print data identified by the document ID sent from the printer 41 (51, 61).

The communicating section 206 implements various data communications with the printer 41 (51, 61) and the communications terminals such as the portable phones 7 of the users via a network interface (not shown) and the Internet. The print request accepting/analyzing section 207 analyzes the contents of the command requesting transmission of the print data based on the document ID, and sends an analysis result to the data retrieving section 205, the controlling section 208, and a relevant section, if necessary.

The controlling section 208 controls operations of the respective sections of the document server 2. Specifically, the controlling section 208 controls the data retrieving section 205 to retrieve the print data from the print data storing section 201 in response to the command requesting printout of the print data, based on the document ID sent from the printer 41 (51, 61), and controls the communicating section 206 to communicate data such as the print data.

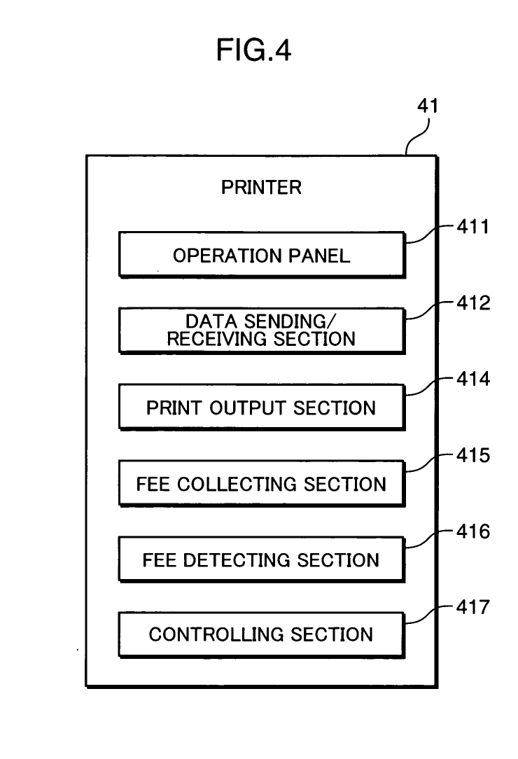

Next, an internal arrangement of the printer 41 (51, 61) is described. Since the internal arrangements of essential parts of the printers 41, 51, and 61 are identical to each other, the internal arrangement of the printer 41 is described as an exemplary arrangement in the following. FIG. 4 is a block diagram showing the internal arrangement of the printer 41. The printer 41 sends, to the document server 2, the document ID entered by the user, and a command requesting transmission of print data. Also, the printer 41 receives, from the document server 2, the print data identified by the document ID to print the received print data.

The printer 41 is provided with an operation panel 411 including a liquid crystal display (LCD) section on which various messages such as a print fee required for manipulating the printer 41 are displayed, and a touch panel section on which the user is allowed to enter designation necessary for printing as well as the document ID, a data sending/receiving section 412 for communicating the document ID, the command requesting transmission of the print data, the print data, and the like with the document server 2, a print output section 414 for image formation and printout of the received print data, a fee collecting section 415 for allowing the user to put in a bank note or a coin as the print fee, a fee detecting section 416 for detecting whether the charged fee has been put in the fee collecting section 415, and a controlling section 417 for controlling the data sending/receiving section 412 for data communication with the document server 2, controlling the fee collecting section 415 for actuation, and controlling the overall operations of the printer 41. The fee collecting section 415 and the fee detecting section 416 may be omitted in the case where settlement is made by electronic money.

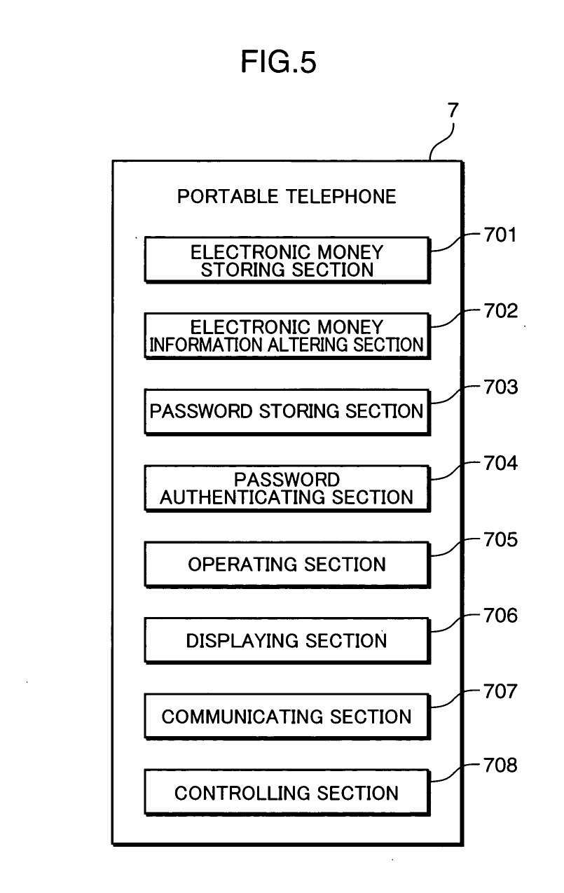

Next, a schematic arrangement of the portable telephone 7, as an example of the communications terminal of the user is described. FIG. 5 is a block diagram showing an internal arrangement of the portable telephone 7. The portable telephone 7 is equipped with conventional parts which exhibits general functions as a communications device, specifically, an operating section 705 such as a ten key and a communications button, a displaying section 706 such as a liquid crystal display (LCD), a communicating section 707 for communicating audio and/or electronic data with an external device, and a controlling section 708 for controlling operations of the respective sections of the portable telephone 7. The portable telephone 7 further includes an electronic money storing section 701, an electronic money information altering section 702, a password storing section 703, and a password authenticating section 704.

The electronic money storing section 701 stores information relating to the amount of electronic money which is altered by addition or subtraction in response to an instruction from the accounting control device 42 (52 or 62). In the present specification and claims, the “electronic money” is electronic information indicative of a value of a currency, and is used as settlement unit in electronic transaction. The electronic money information altering section 702 alters the amount of electronic money stored in the electronic money storing section 701 by addition or subtraction in response to an instruction from the accounting control device 42 (52 or 62).

The password storing section 703 stores a password which is used in allowing the electronic money information altering section 702 to rewrite the data stored in the electronic money storing section 701. The password authenticating section 704 judges whether the password entered to the operating section 705 coincides with the password stored in the password storing section 703. In the case where the password authenticating section 704 judges that the password entered to the operating section 705 coincides with the password stored in the password storing section 703, the controlling section 708 allows the electronic money information altering section 702 to alter the amount of electronic money stored in the electronic money storing section 701 in response to an instruction from the accounting control section 42 (52 or 62). This arrangement prohibits a person other than the owner of the portable telephone 7 or a person to whom use of the portable telephone 7 has been authorized to make settlement by electronic money, thereby providing security measures in the electronic money settlement.

The history of transaction such as the used amount of electronic money in each transaction, the balance, and the like are displayed in time series on the displaying section 706 based on the information stored in the electronic money storing section 701, under the control of the controlling section 708.

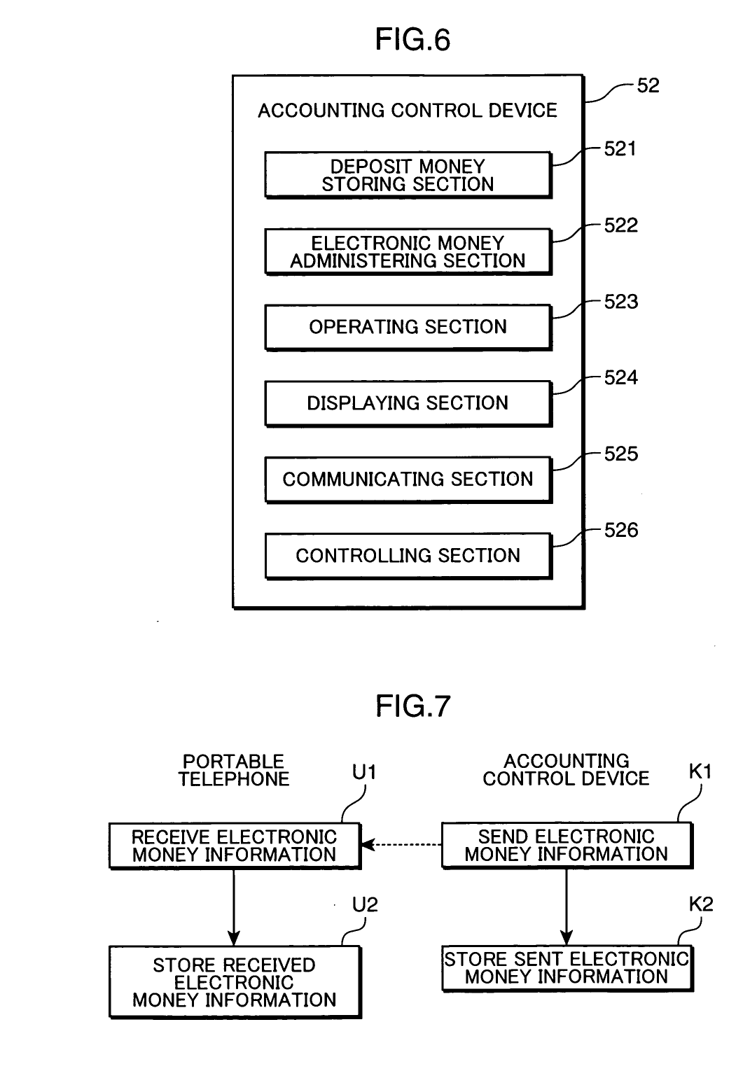

Next, a schematic arrangement of the accounting control device is described. FIG. 6 is a block diagram showing an internal arrangement of the accounting control device. Since the accounting control device 42 (52 or 62) respectively provided in the convenience store 4, the print station 5, and the hotel 6 are identical to each other in arrangement, the arrangement of the accounting control device 52 is described as an exemplified arrangement of the accounting control device in the following. The accounting control device 52 includes a deposit money storing section 521, an electronic money administering section 522, an operating section 523, a displaying section 524, a communicating section 525, and a controlling section 526.

The deposit money storing section 521 stores information relating to the amount of electronic money which has been deposited in the portable telephone 7. The electronic money administering section 522 sends an instruction to the portable telephone 7 that a certain amount of electronic money is added or subtracted. Then, the electronic money administering section 522 alters the amount of electronic money stored in the deposit money storing section 521 by addition or subtraction by the amount of electronic money to be added or subtracted whose data has been sent to the portable telephone 7, so that the amount of electronic money stored in the deposit money storing section 521 matches with the amount of electronic money stored in the electronic money storing section 701 of the portable telephone 7 with respect to each portable telephone 7.

“To deposit electronic money” in the present specification and claims means that a certain amount of electronic money is transferred, in the concept of electronic transaction, to the portable telephone 7, by controlling the electronic money information altering section 702 of the portable telephone 7 to alter information relating to electronic money stored in the electronic money storing section 701 by adding the certain amount of electronic money, in response to an instruction of adding the certain amount of electronic money which is sent from the electronic money administering section 522 to the portable telephone 7 by way of the communicating section 525.

The operating section 523 accepts input of the amount of electronic money to be deposited to the portable telephone 7, namely, the amount of electronic money to be stored in the deposit money storing section 521, and designation of various operation commands entered by an shop attendant. The displaying section 524 includes a liquid crystal display (LCD), and displays various information such as the amount of electronic money to be deposited to the portable telephone 7, namely, the amount of electronic money to be stored in the deposit money storing section 521.

The communicating section 525 communicates with the portable telephone 7 and the document server 2 by sending an instruction. The communicating section 525 transmits to the portable telephone the instruction which add or subtract electronic money issued from the electronic money administering section 522. The communicating section 525 notifies the balance of the electronic money stored in the electronic money storing section 701 of the portable phone 7 to the document server 2. These operations are, for example, realized by Bluetooth® wireless technology or via the Internet communications. The controlling section 526 controls operations of the respective sections of the accounting control device 52.

Next, a process as to how electronic money information is communicated between the portable telephone 7 and the accounting control device 52. FIG. 7 is an illustration showing a process as to how electronic money information is added in the portable telephone 7 and in the accounting control device 52. Steps to be implemented by the accounting control device 52 are referred to as Steps K1, K2 . . . , and steps to be implemented by the portable telephone 7 are referred to as Steps U1, U2 . . . .

The accounting control device 52 is installed in the convenience store 4, the print station 5, the hotel 6, or a like facility. In case of depositing electronic money in the portable telephone 7, for instance, in response to a user's payment of a certain amount of money by cash, a shop attendant in the convenience store 4 or the like enters data indicative of the amount of money on the operating section 523 of the accounting control device 52. Upon the entry on the operating section 523, a command of adding a certain amount of electronic money equivalent to the entered amount of money is sent from the electronic money administering section 522 to the portable telephone 7 by way of the communicating section 525 by using Bluetooth® wireless technology or the like (Step K1). The information relating to the amount of electronic money which has been transmitted to the portable telephone 7 is stored in the deposit money storing section 521 with respect to each portable telephone 7, and is administered by the electronic money administering section 522 (Step K2). Referring to the operations of the portable telephone 7, upon receiving the command of adding the certain amount of electronic money from the accounting control device 52 (Step U1), the information relating to the amount of electronic money is stored in the electronic money storing section 701 (Step U2).

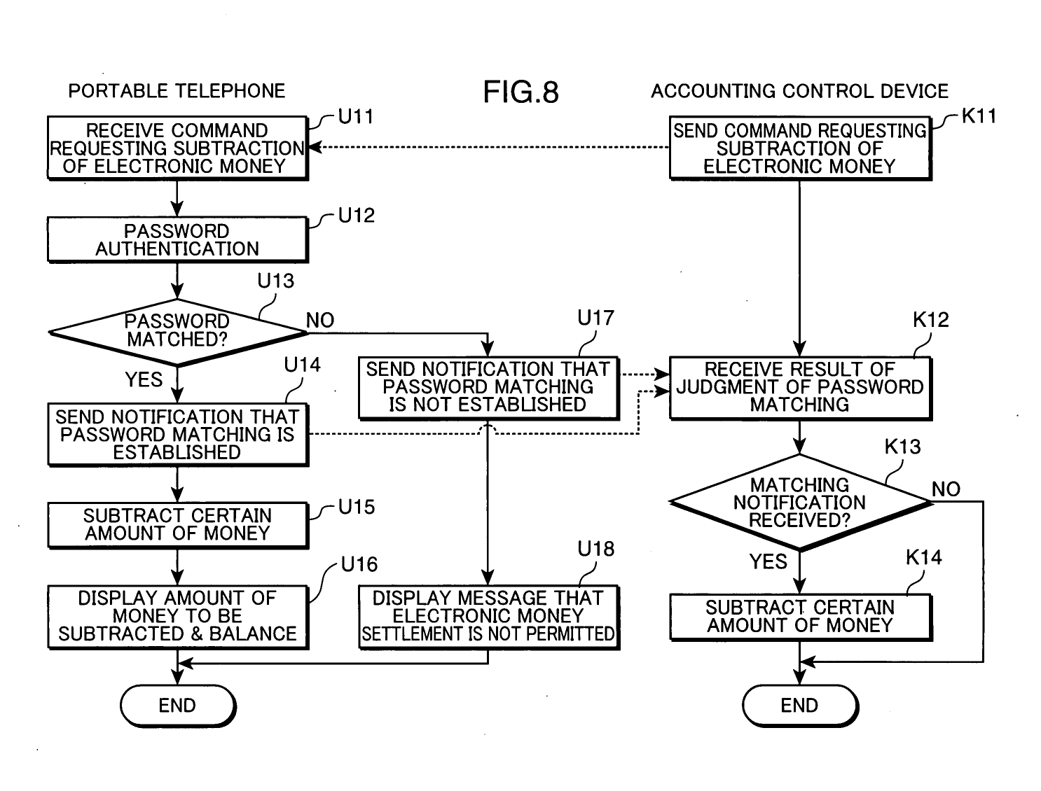

FIG. 8 is an illustration showing a process as to how settlement is made by electronic money between the portable telephone 7 and the accounting control device 52, namely how the electronic money information is subtracted in the portable telephone 7 and in the accounting control device 52. In case of subtracting the amount of electronic money equivalent to the price of goods (in this case, print data such as paid contents) from the data stored in the electronic money storing sections 701 of the portable telephone 7 in settlement, for instance, in response to input of the amount of money equivalent to the price of goods on the operating section 523 of the accounting control device 52 by the shop attendant in the convenience store 4, a command of subtracting the amount of electronic money equivalent to the inputted amount of money is sent from the electronic money administering section 522 to the portable telephone 7 by way of the communicating section 525 (Step K11).

Referring to the operations of the portable telephone 7, upon receiving the command of subtracting the amount of electronic money from the accounting control device 52 (Step U11), the password authenticating section 704 judges whether the password entered on the operating section 705 by the user coincides with the password stored in the password storing section 703 (Step U12). If it is judged that the password entered on the operating section 705 coincides with the password stored in the password storing section 703 (YES in Step U13), a notification indicating the password matching is sent to the accounting control device 52 (Step U14). Thereafter, the electronic money information altering section 702 subtracts the amount of electronic money from the amount of electronic money stored in the electronic money storing section 701 in accordance with the command of subtracting the amount of electronic money sent from the accounting control device 52 (Step U15). The amount of electronic money to be subtracted, and the balance of electronic money after the subtraction are displayed on the displaying section 706 (Step U16). The authentication of the password may be implemented prior to the step in which the portable telephone 7 receives the command of subtracting the amount of electronic money from the accounting control device 52, and the controlling section 708 may allow the communicating section 707 to receive the command of subtracting the amount of electronic money from the accounting control device 52 only after the password matching is established.

If the entered password does not coincide with the stored password (NO in Step U13), a notification indicating password non-matching is sent to the accounting control device 52 (Step U17), and a message indicating that electronic money settlement is not permitted is displayed on the displaying section 706 (Step U18).

Referring to the operations of the accounting control device 52, after a result of password authentication is received from the portable telephone 7 (Step K12), if the password matching notification is received (YES in Step K13), the electronic money administering section 522 subtracts the amount of electronic money equivalent to the price of goods which has been entered on the operating section 513 in Step K11, from the amount of electronic money stored in the deposit amount storing section 521 (Step K14). The result of the subtraction is administered with respect to each portable telephone 7. If the password non-matching notification is received (NO in Step K13), electronic money settlement is not executed, and the routine ends by skipping Step K14.

According to the above process, a holder of the password is exclusively authorized to make settlement by way of the portable telephone 7, and settlement by an unauthenticated person is prohibited. This arrangement contributes to improvement on security measures in electronic transaction.

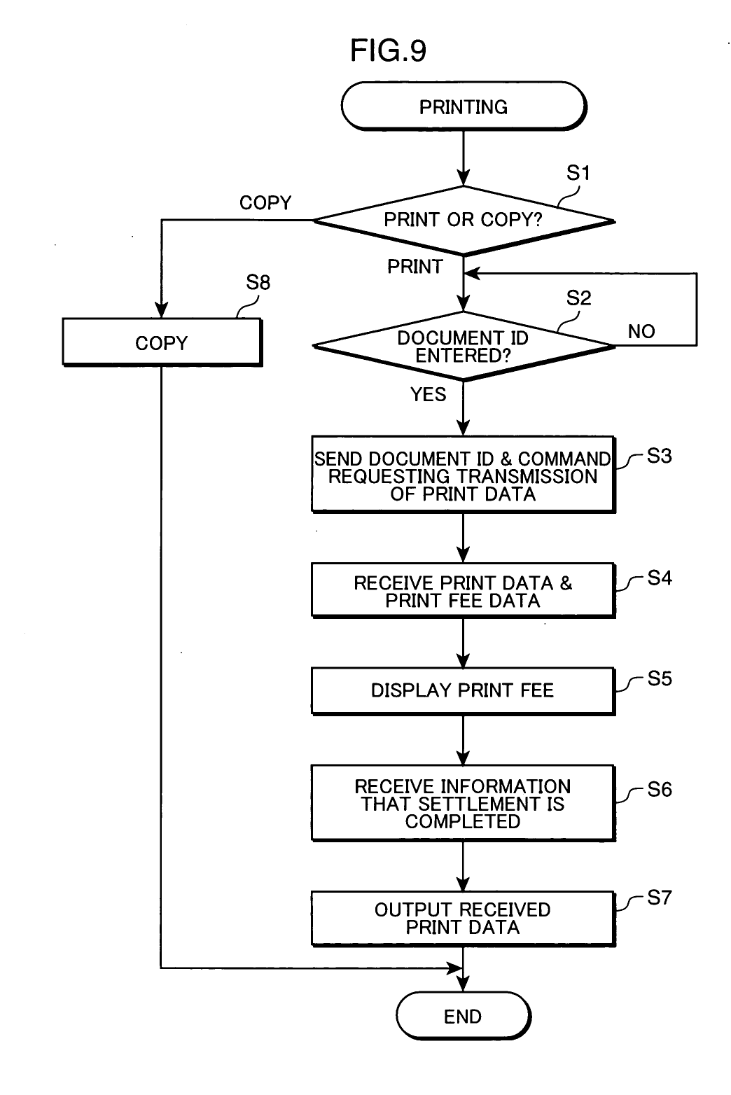

Now, an exemplified process of printing by the printer 41 in the wide area network printing system 1 is described. FIG. 9 is a flowchart showing the printing process. First, copy mode or print mode is selected by a designation of the user on the operation panel 411. If the controlling section 417 judges that copy mode is designated (COPY in Step S1), an ordinary copying process is implemented (Step S8).

If the controlling section 417 judges that print mode is designated (PRINT in Step S1), the controlling section 417 controls the data sending/receiving section 412 to send, to the document server 2, the entered document ID, and a command requesting transmission of print data identified by the document ID (YES in Step S2, Step 3). When the data sending/receiving section 412 receives the print data identified by the document ID, the print fee data, and the like from the document server 2 (Step S4), the controlling section 417 controls the display section of the operation panel 411 to display the print fee, based on the received print fee data (Step S5). After receiving information indicating that the electronic money settlement is completed from the accounting control device 52 (Step S6), the controlling section 526 controls the print output section 414 to print out the received print data (Step S7). Alternatively, the routine may allow the user to pay the print fee by cash or other means on-site in the shop where the printer 41 is installed or a like facility, without implementing Step S6. Further alternatively, the print fee may be calculated by the printer, based on the number of copy sheets necessary for output of the print data.

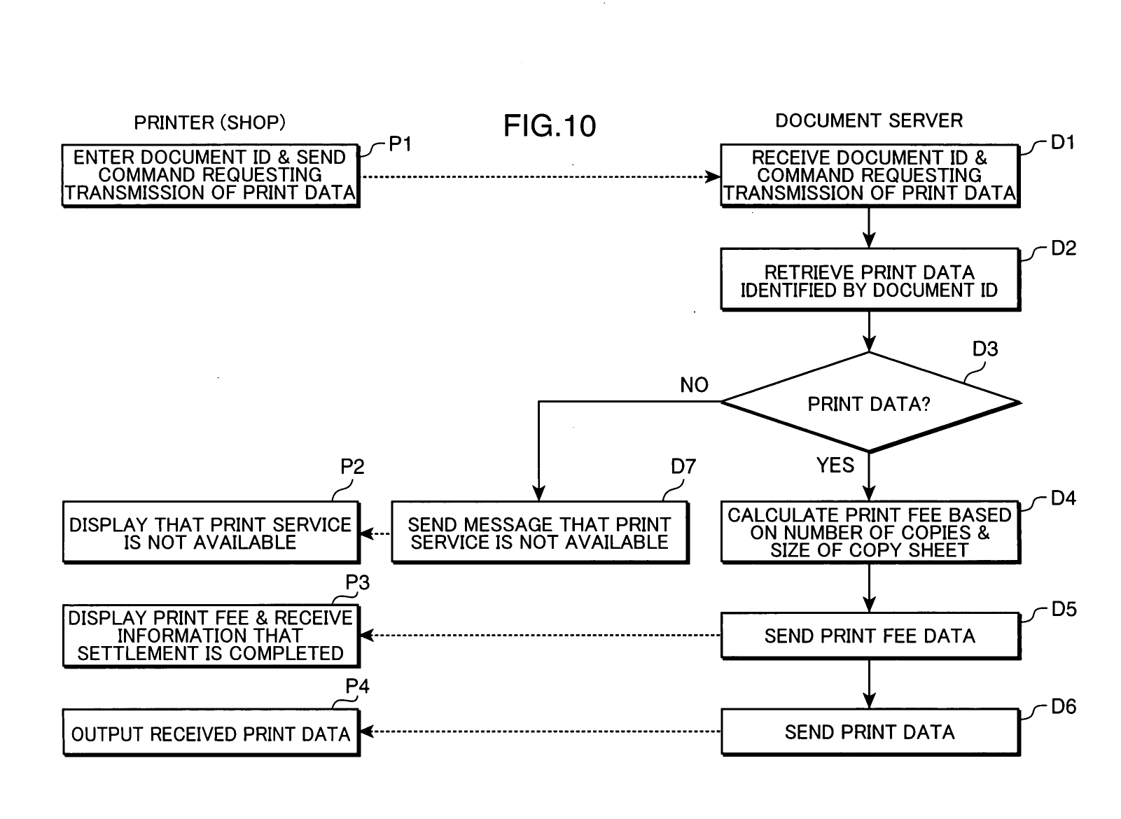

A process by the document server 2 in printing in the wide area network printing system 1 is described in correlation with the process by the printer 41. FIG. 10 is a flowchart showing the processes by the document server 2 and the printer 41. Steps to be implemented by the printer are referred to as Steps P1, P2, . . . , and steps to be implemented by the document server 2 are referred to as Steps D1, D2, . . . .

When the document ID is entered on the printer 41, the entered document ID, and a command requesting transmission of print data identified by the entered document ID are sent to the document server 2 (Step P1). Upon receiving the document ID and the command requesting transmission of print data from the printer 41 (Step D1), the print data identified by the document ID is retrieved from the print data storing section 201 (Step D2).

If it is judged that the print data storing section 201 stores the print data identified by the document ID (YES in Step D3), for example, the controlling section 208 calculates the print fee based on the number of copy sheets necessary for printing the print data, the size of the copy sheet, or the like (Step D4). Subsequently, the controlling section 208 controls the communicating section 206 to send, to the printer 41, the print fee data and the print data (Steps D5, D6). Upon receiving the print data and the print fee data, the printer 41 causes the display section thereof to display the print fee, and receives information that the settlement by electronic money is completed from the accounting control device 52 (Step P3). Thereupon, the printer 41 executes printout of the received print data (Step P4).

On the other hand, if it is judged that the print data storing section 201 does not store the print data identified by the document ID (NO in Step D3), the controlling section 208 controls the communicating section 206 to send, to the printer 41, information indicating that print service of the requested print data is not available (Step D7). Upon receiving the information, the printer 41 causes the display section of the operation panel 411 to display a message that print service of the requested print data is not available (Step P2).

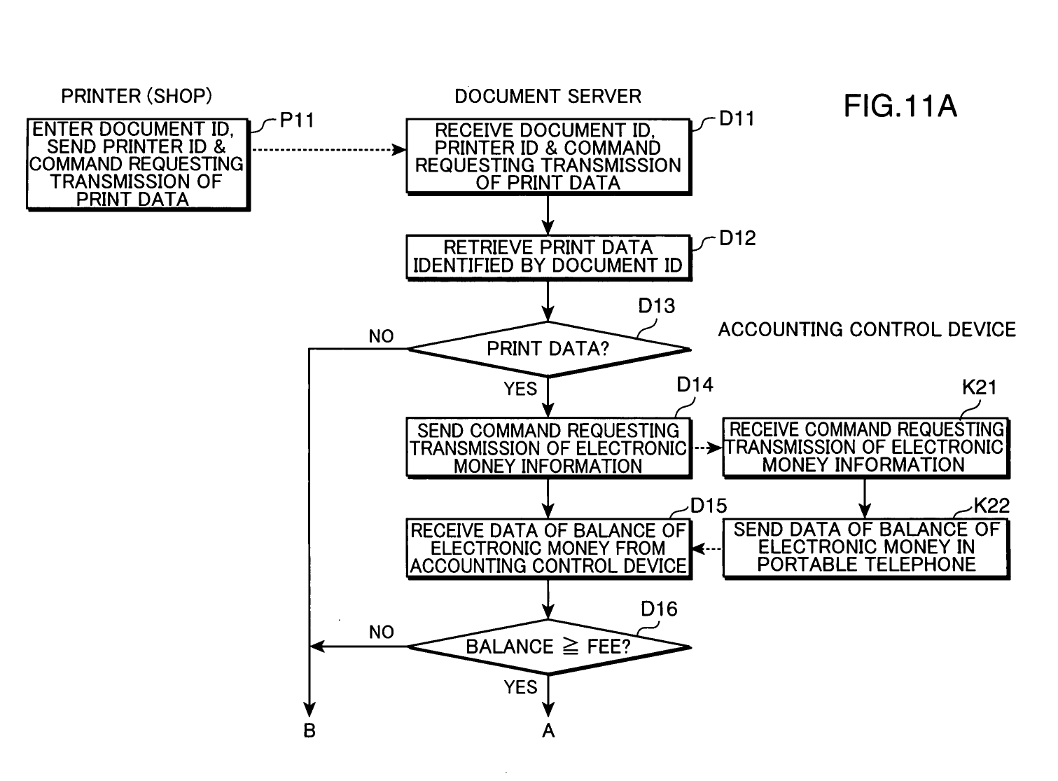

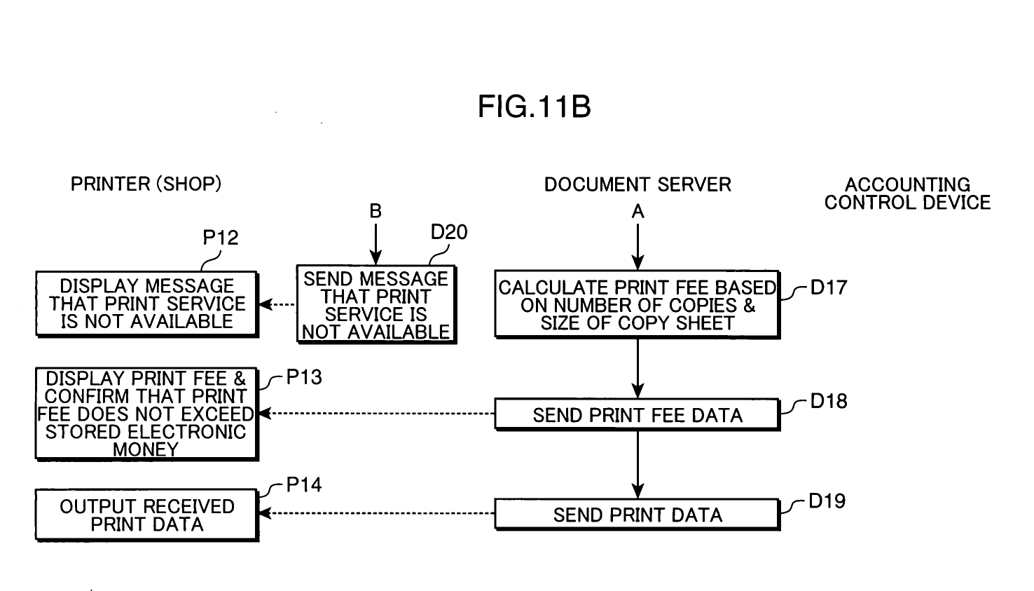

Next, a second embodiment of the present invention regarding the processes by the document server 2 and the printer 41 in printing in the wide area network printing system 1 is described. FIGS. 11A and 11B are flowcharts showing the processes by the document server 2 and the printer 41 in the second embodiment. Description on steps in the second embodiment which are identical to those in FIG. 10 are omitted herein.

The second embodiment is so configured as to send print data to the printer 41 in the case where the document server 2 is notified of a status of the balance of electronic money in the portable telephone 7 from the accounting control device 52, and confirms that the price of goods, namely, the print fee does not exceed the balance.

If it is judged that the print data storing section 201 stores the print data identified by the document ID sent from the printer 41, the controlling section 208 of the document server 2 controls the communicating section 206 to send, to the accounting control device 52, a command requesting transmission of electronic money information of the portable telephone 7, namely, the balance of electronic money stored in the electronic money storing section 701 of the portable telephone 7 (Step D14).

Upon receiving the command requesting transmission of the electronic money information from the document server 2 (Step K21), the controlling section 526 of the accounting control device 52 controls the deposit money storing section 521 to read out the balance of electronic money regarding the portable telephone 7, and controls the communicating section 525 to send the balance to the document server 2 (Step K22).

Upon receiving the electronic money information of the portable telephone 7 from the accounting control device 52 (Step D15), the controlling section 208 of the document server 2 judges whether the electronic money storing section 701 of the portable telephone 7 stores the balance of electronic money of not lower than the print fee, based on the received electronic money information (Step D16). If it is judged that the electronic money storing section 701 stores the balance of electronic money of not lower than the print fee (YES in Step D16), then, the controlling section 208 controls the communicating section 206 to send, to the printer 41, the print data and the print fee data (Steps D17 to D19). If it is judged that the electronic money storing section 701 does not store the balance of electronic money of not lower than the print fee (NO in Step D16), then, the controlling section 208 controls the communicating section 206 to send, to the printer 41, information indicating that print service of the requested print data is not available (Step D20), and the printer 41 causes the display section thereof to display that print service of the requested print data is not available (Step P12).

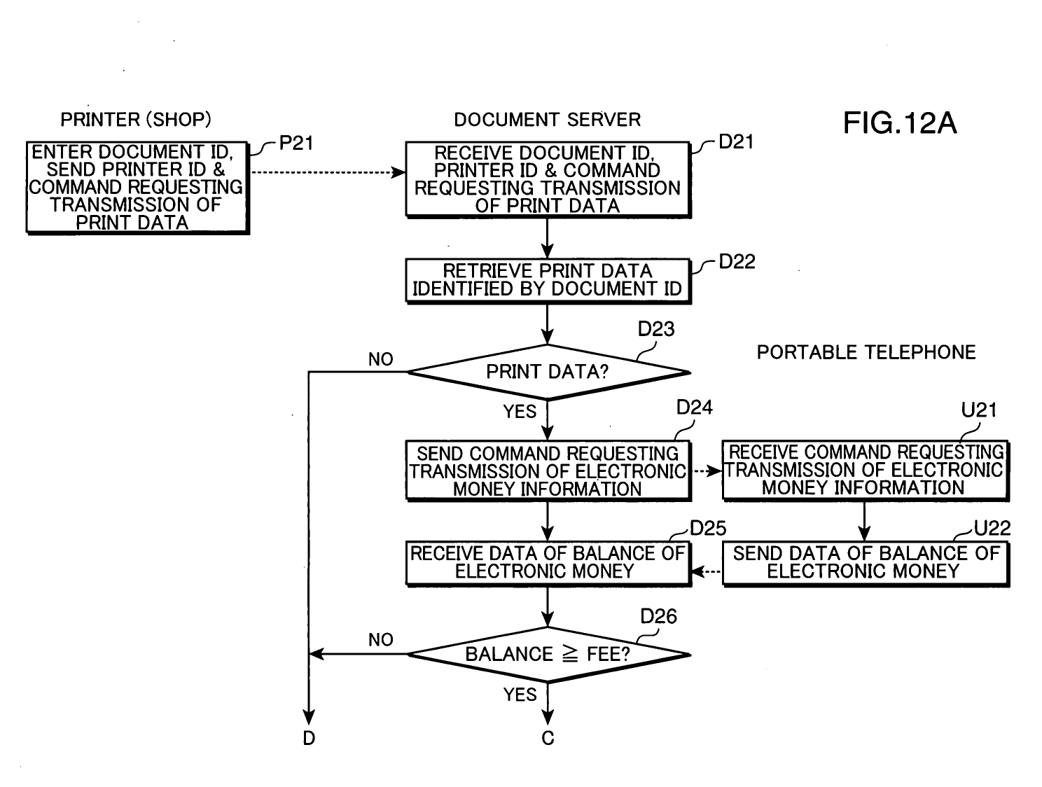

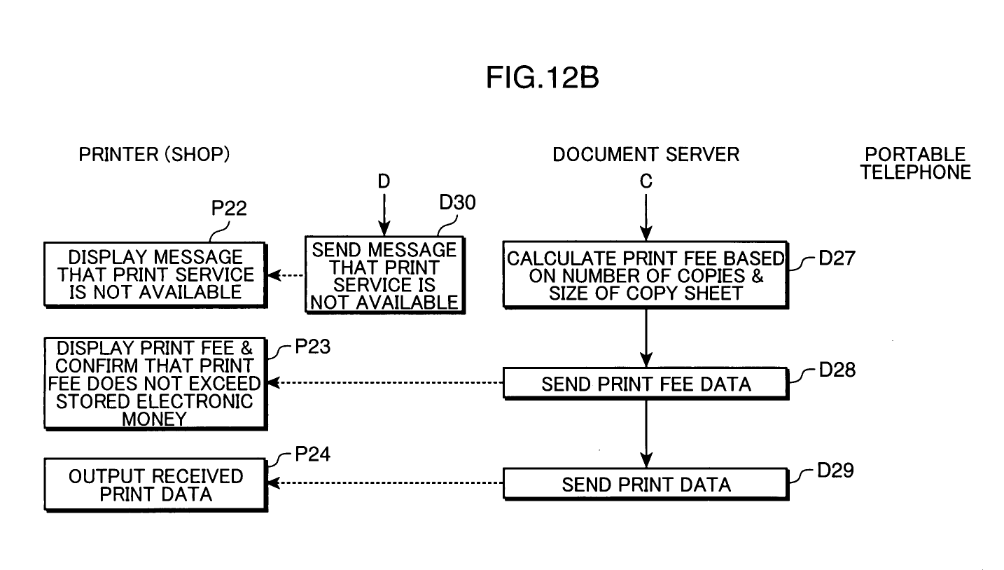

Next, a third embodiment of the processes by the document server 2 and the printer in printing in the wide area network printing system 1 is described. FIGS. 12A and 12B are flowcharts showing the processes by the document server 2 and the printer 41 in the third embodiment. Description on the processes in the third embodiment which are identical to those in FIGS. 10, 11A and 11B are omitted herein.

The second embodiment is so configured that the document server 2 is notified that the print fee does not exceed the balance of electronic money by receiving information relating to the status of the balance of electronic money of the portable telephone 7. Alternatively, the document server 2 may directly receive information relating to the balance of electronic money of the portable telephone 7 from the portable telephone 7.

In the third embodiment, the controlling section 208 of the document server 2 controls the communicating section 206 to send, to the portable telephone 7, a command requesting transmission of electronic money information via the Internet or the like (Step D24). Upon receiving the command (Step U21), the controlling section 708 of the portable telephone 7 controls the electronic money storing section 701 to read out the balance of electronic money, and controls the communicating section 707 to send, to the document server 2, the read-out the balance of electronic money (Step U22). Upon receiving the electronic money information from the portable telephone 7 (Step D25), the controlling section 208 of the document server 2 judges whether the electronic money storing section 701 of the portable telephone 7 stores the balance of not lower than the print fee, based on the received electronic money information (Step D26). If it is judged that the electronic money storing section 701 stores the balance of not lower than the print fee (YES in Step D26), the controlling section 208 controls the communicating section 206 to send, to the printer 41, the print data and the print fee data (Steps D27 to D29). If it is judged that the electronic money storing section 701 does not store the balance of not lower than the print fee (NO in Step D26), the controlling section 208 controls the communicating section 206 to send, to the printer 41, information indicating that print service of the requested print data is not available (Step D30). Then, the printer 41 causes the display section thereof to display that print service of the requested print data is not available.

According to the processes in FIGS. 11A, 11B, 12A and 12B, as far as the print fee does not exceed the balance of electronic money stored in the electronic money storing section 701 of the portable telephone 7, the requested print data is sent from the document server 2 to the printer 41. Thereby, the print fee is securely collected by electronic money settlement using the portable telephone 7.

Alternatively, the system may be so configured that the controlling section 208 of the document server 2 controls the communicating section 206 to send the print data to the printer 41 if the communicating section 206 receives, from the portable telephone 7 or from the accounting control device 52, a notification indicating that the amount of electronic money equivalent to the print fee is subtracted in the portable telephone 7. The altered arrangement makes it possible to more securely collect the print fee by electronic money settlement using the portable telephone 7.

In this way, the wide area network printing system 1 in the foregoing embodiments are advantageous in: (1) obtaining print data stored in the document server 2 by the printer 41 (51 or 61) which is installed remotely away from the document server 2 but is communicatively connected therewith via the Internet; (2) making cashless settlement of the print fee feasible by using the portable telephone 7, which is an inherently necessary tool for the user to receive the document ID for identifying the print data from the document server 2, as well as making it easy for the user to recognize the history of transaction such as the used amount of electronic money in each transaction, and the balance of electronic money through the displaying section 706 of the portable telephone 7; and in (3) making it possible for the user to confirm the contents of the print data through the displaying section 706 of the portable telephone 7. With these arrangements, operability of printing by the wide area network printing system 1 are remarkably improved.

Since a memory provided in the portable telephone 7 can be used as the electronic money storing section 701, data can be rewritten an unlimited number of times. This arrangement is economically advantageous, compared with the conventional art of using the prepaid card in which the history of use is recorded on the backside of the card, and the card is discarded after the prepaid amount is used up.

The present invention is not limited to the foregoing embodiments, and various modifications and alterations are applicable. In the above embodiments, described is the case where the inventive electronic transaction system is applied to settlement in the wide area network printing system 1. Alternatively, the inventive electronic transaction system may be applicable to transaction other than the settlement in the wide area network printing system.

In the foregoing embodiments, the inventive electronic transaction system is described, taking an example in which electronic money information is stored in the portable telephone 7, and the portable telephone 7 is used in settlement. Alternatively, an arrangement similar to the arrangement of the portable telephone 7 may be provided in the other communications terminal of the user, such as the PC 9 or the PDA 10, and settlement may be made with use of the PC 9 or the PDA 10.

Further, in the foregoing embodiments, the thumbnail image data generating section 203 of the document server 2 generates thumbnail image data representing respective print data stored in the print data storing section 201. Alternatively, a thumbnail image data storing section storing thumbnail image data representing respective print data stored in the print data storing section 201 may be provided, in place of the thumbnail image data generating section 203.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An electronic transaction system provided with a communications terminal storing information relating to electronic money therein, and an accounting control device for allowing users to make settlement by electronic transaction by data communication with the communications terminal, wherein
the communications terminal includes:
a storing unit that stores a certain amount of electronic money therein;
an electronic money information altering unit that alters the amount of electronic money stored in the storing unit in response to an instruction from the accounting control device; and
a display which displays the amount of electronic money stored in the storing unit, and
the accounting control device includes:
a deposit money storing unit that stores a certain amount of electronic money deposited in the communications terminal therein;
a transmitting unit that transmits a command requesting addition or subtraction of electronic money to the communications terminal; and
an electronic money administering unit that alters the amount of electronic money stored in the deposit money storing unit in response to the command requesting addition or subtraction of electronic money sent from the transmitting unit.

2. The system according to claim 1, wherein the communications terminal includes:
a password storing unit that stores a password used in permitting alteration of the amount of electronic money stored in the storing unit of the communications terminal;
a password input unit that allows the user to input an arbitrary digit or digits indicative of a password by external manipulation;
an authenticating unit that judges whether the password inputted by the password input unit coincides with the password stored in the password storing unit; and
a controlling unit that controls the electronic money information altering unit to alter the data indicative of the amount of electronic money stored in the storing unit of the communications terminal in response to the instruction sent from the accounting control unit if the authenticating unit judges that the password inputted by the password input unit coincides with the password stored in the password storing unit.

3. A communications terminal comprising a storing unit that stores a certain amount of electronic money therein, a electronic money information altering unit that alters the amount of electronic money stored in the storing unit, and a display which displays the amount of electronic money stored in the storing unit.

4. A wide area network printing system which is so configured as to allow users to print out print data sent from a server by an image forming apparatus which is installed remotely away from the server but is communicatively connected therewith via the Internet, the system provided with a communications terminal storing information relating to electronic money therein, and an accounting control device which allows the users to make settlement of a print fee corresponding to the print data by data communication with the communications terminal, wherein
the accounting control device includes:
a deposit money storing unit that stores a certain amount of electronic money deposited in the communications terminal of the user;
a transmitting unit that transmits a command requesting addition or subtraction of electronic money to the communications terminal; and
an electronic money administering unit that alters the amount of electronic money stored in the deposit money storing unit in response to the command requesting addition or subtraction of electronic money sent from the transmitting unit, and
the communications terminal includes:
a document ID receiving unit that receives a document ID for identifying the print data from the server;
a sending/receiving unit that communicates data with the accounting control device;
a storing unit that stores a certain amount of electronic money therein,
an electronic money information altering unit that alters the amount of electronic money stored in the storing unit therein in response to an instruction from the accounting control unit; and
a display which displays the amount of electronic money stored in the storing unit,
the server includes:
a data sending/receiving unit that communicates various data with the image forming apparatus;
a print data storing unit that stores the print data therein;
a document ID storing unit that stores the document ID for identifying the print data stored in the print data storing unit; and
a document ID transmitting unit that transmits the document ID stored in the document ID storing unit to the communications terminal of the user, and
the image forming apparatus includes:
an accepting unit that accepts input of the document ID by the user;
a transmitting unit that transmits the document ID inputted to the accepting unit;
a receiving unit that receives the print data from the server; and
an outputting unit that prints out the received print data, whereby
the server reads out the print data identified by the document ID from the print data storing unit, and sends the print data to the image forming apparatus in response to receiving the document ID from the transmitting unit of the image forming apparatus.

5. The system according to claim 4, wherein the server includes thumbnail image data generating unit that generates thumbnail image data representing the print data stored in the print data storing unit, and the server is operative to allow the data sending/receiving unit to send the document ID for identifying the print data, and the thumbnail image data to the communications terminal.

6. The system according to claim 4, wherein the data sending/receiving unit of the server is operative to communicate various data with the communications terminal or the accounting control device, and to send the print data to the image forming apparatus in response to receiving, from the communications terminal or from the accounting control device, a notification notifying that a certain amount of electronic money equivalent to the price of the print data is subtracted in the communications terminal.

7. The system according to claim 5, wherein the data sending/receiving unit of the server is operative to communicate various data with the communications terminal or the accounting control device, and to send the print data to the image forming apparatus in response to receiving, from the communications terminal or from the accounting control device, a notification notifying that a certain amount of electronic money equivalent to the price of the print data is subtracted in the communications terminal.

8. The system according to claim 4, wherein the data sending/receiving unit of the server is operative to communicate various data with the communications terminal or the accounting control device, and to send the print data to the image forming apparatus in response to receiving, from the communications terminal or from the accounting control device, information relating to the electronic money stored in the storing unit of the communications terminal, and based on a judgment that the price of the print data whose transmission has been requested from the communications terminal does not exceed the amount of electronic money stored in the storing unit.

9. The system according to claim 5, wherein the data sending/receiving unit of the server is operative to communicate various data with the communications terminal or the accounting control device, and to send the print data to the image forming apparatus in response to receiving, from the communications terminal or from the accounting control device, information relating to the electronic money stored in the storing unit of the communications terminal, and based on a judgment that the price of the print data whose transmission has been requested from the communications terminal does not exceed the amount of electronic money stored in the storing unit.
